(19) United States
(12) Patent Application Publication
(10) Pub. No.: US 2015/0378313 A1
(43) Pub. Date: Dec. 31, 2015

(54) ELECTRONIC DEVICE

(71) Applicant: CASIO COMPUTER CO., LTD., Tokyo (JP)

(72) Inventors: Kazuaki ABE, Iruma-shi (JP); Yohei KAWAGUCHI, Tokyo (JP)

(73) Assignee: CASIO COMPUTER CO., LTD., Tokyo (JP)

(21) Appl. No.: 14/729,414

(22) Filed: Jun. 3, 2015

(30) Foreign Application Priority Data
Jun. 30, 2014 (JP) 2014-133744

(51) Int. Cl. G04C 10/02

(52) U.S. Cl. CPC G04C 10/02

(57) ABSTRACT

An electronic device includes a solar panel, a secondary battery, an antenna and a circuit board. The solar panel receives light to generate electric power. The secondary battery stores electric power generated by the solar panel. The antenna is disposed near the solar panel and receives electric waves with a predetermined frequency. The circuit board electrically connects the solar panel and the secondary battery. On a wiring route which is formed on the circuit board so as to electrically connect the solar panel and the secondary battery, at least one circuit element is provided so as to have high electric resistance with respect to electric waves which are received by the antenna while having low electric resistance with respect to a generated current from the solar panel.

### CROSS-REFERENCE TO RELATED APPLICATION

This application claims priority based on Japanese Patent Application No. 2014-133744, filed on Jun. 30, 2014, the entire contents of which are incorporated by reference herein.

### BACKGROUND OF THE INVENTION

The present invention relates to an electronic device.

For example, JP-A-2010-066151 discloses a configuration for interrupting an electrical connection between a solar panel and a secondary battery during electric wave reception of an antenna, by means of switching control of a switching element, to suppress deterioration of antenna characteristics.

However, since the above described configuration needs a dedicated switching element for a control circuit and should perform troublesome switching control according to an electric wave reception state, the configuration is complicated.

Further, since it is impossible to store electric power generated by the solar panel in the secondary battery during electric wave reception, the power storage amount (charge amount) of the secondary battery decreases that much.

The present invention is an electronic device having a simple configuration, capable of appropriately performing reception of electric waves with a predetermined frequency and capable of storage of electric power in a secondary battery.

### SUMMARY OF THE INVENTION

In order to solve the above described problems, an electronic device according to the present invention includes a solar panel, a secondary battery, an antenna and a circuit board. The solar panel receives light to generate electric power. The secondary battery stores electric power generated by the solar panel. The antenna is disposed near the solar panel and receives electric waves with a predetermined frequency. The circuit board electrically connects the solar panel and the secondary battery. On a wiring route which is formed on the circuit board so as to electrically connect the solar panel and the secondary battery, at least one circuit element is provided so as to have high electric resistance with respect to electric waves which are received by the antenna while having low electric resistance with respect to a generated current from the solar panel.

### BRIEF DESCRIPTION OF THE DRAWINGS

FIG. 1 is an exploded perspective view of a timepiece according to an embodiment.

FIG. 2 is a schematic side view illustrating an internal configuration of a module according to the embodiment.

FIG. 3 is a schematic block diagram illustrating a control configuration of the timepiece according to the embodiment.

FIG. 4 is a schematic block diagram illustrating a modification of the control configuration of the timepiece according to the embodiment.

FIG. 5 is a plan view of a solar panel according to the embodiment.

FIG. 6 is a cross-sectional view of the solar panel along a line VI-VI of FIG. 5.

FIG. 7 is a plan view illustrating a modification of the solar panel according to the embodiment.

FIG. 8 is a cross-sectional view of the modification of the solar panel along a line VIII-VIII of FIG. 7.

FIG. 9 is a plan view illustrating another modification of the solar panel according to the embodiment.

### DETAILED DESCRIPTION

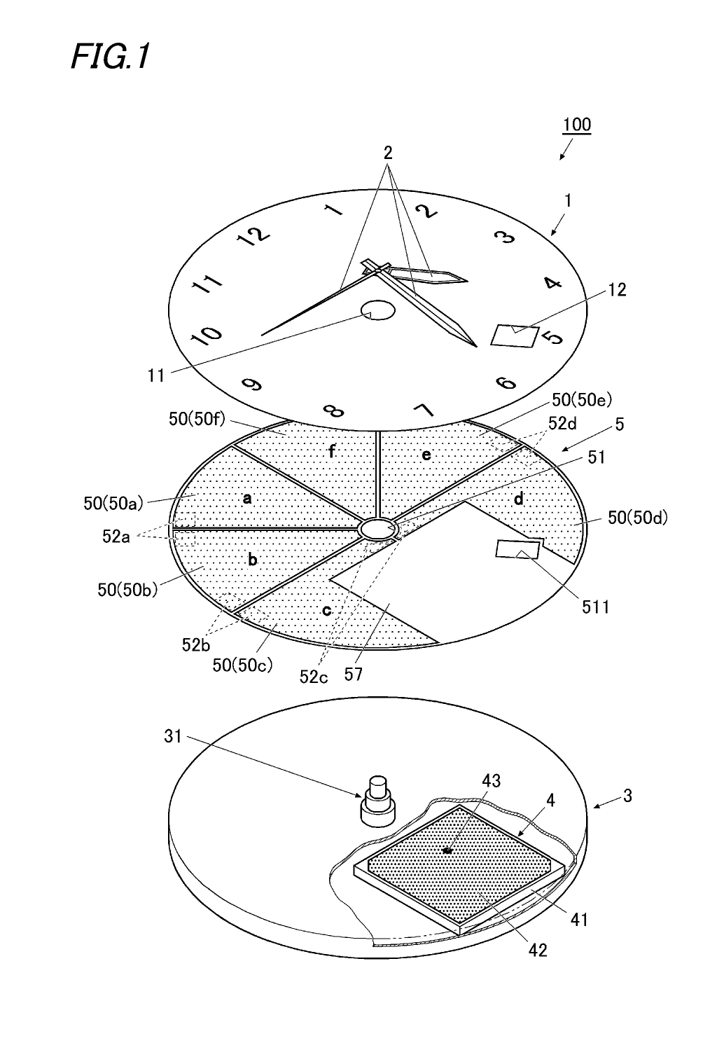

Embodiments of an electronic device according to the present invention will be described with reference to FIGS. 1 to 6.

Additionally, although the after-mentioned embodiments are provided with various technically preferred limitations to perform the present invention, the scope of the present invention is not limited to the following embodiments and illustrated examples.

In the present embodiment, a case where the electronic device is an analog type timepiece (electronic timepiece) which operates clock hands, thereby displaying time and the like.

FIG. 1 is an exploded perspective view of a timepiece 100 according to the present embodiment.

As shown in FIG. 1, the timepiece 100 of the present embodiment includes a dial plate 1, a module 3 including a circularly polarized antenna 4, and a solar panel 5.

The dial plate 1, the module 3, the circularly polarized antenna 4, and the solar panel 5 are housed in a case (not shown).

In the present embodiment, the dial plate 1 is disposed on the viewable side of the timepiece 100. And, the dial plate 1 is an analog type dial plate for displaying time by clock hands 2 such as an hour hand and a minute hand.

In an approximately central portion of the dial plate 1, a through-hole 11 for inserting a hand spindle 31 for fitting the clock hands 2 is formed.

The timepiece 100 of the present embodiment includes the circularly polarized antenna 4 for receiving GPS electric waves which are microwaves, as described below. Therefore, it is preferable that the dial plate 1 is made of a non-magnetic material transmitting microwaves. The dial plate 1 can be made of, for example, a resin or glass.

Further, the timepiece 100 includes the solar panel 5 for receiving light and generating electric power. Therefore, the dial plate 1 is made of a transparent or semitransparent material having optical transparency.

The dial plate 1 may be formed, for example, by depositing a metal film or by performing various printing on a surface of a base material. The base material can be made of a transparent or semitransparent material such that a resin or glass. The metal film is so thick that it does not attenuate microwaves and does not disturb light transmission.

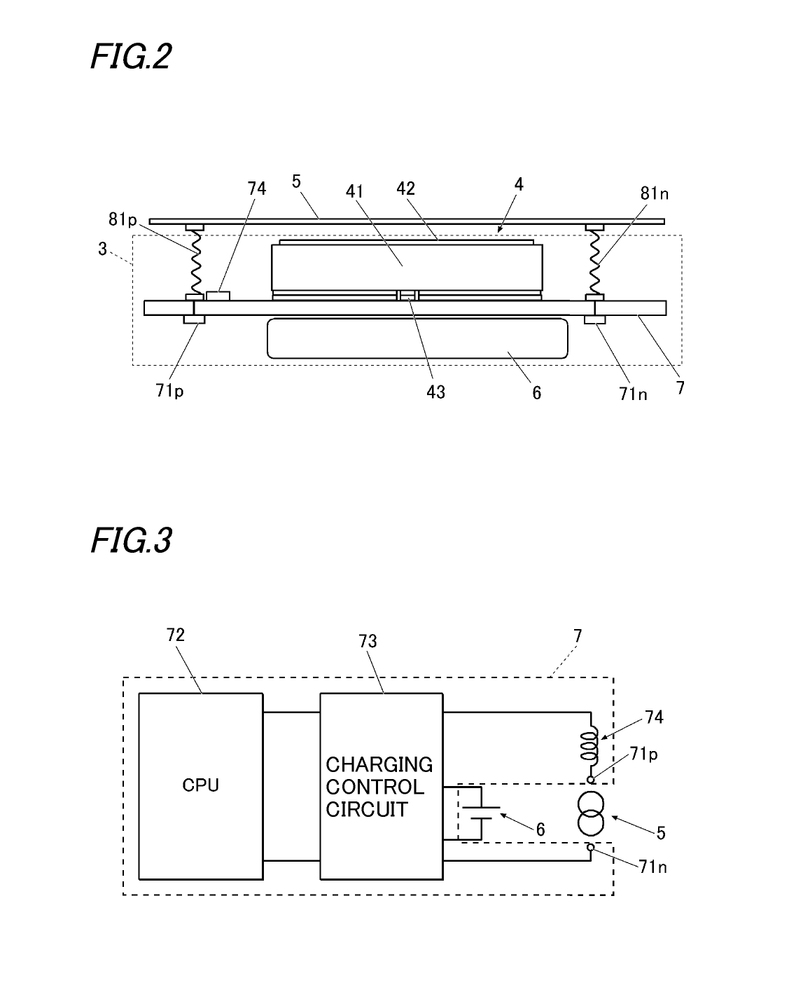

The module 3 is disposed below the dial plate 1 and the solar panel 5 (that is, on the rear side of the timepiece 100). The module 3 is formed, for example, to include a timepiece movement which is configured by a gear train mechanism, a motor, and the like for operating the clock hands 2, and a communication module which is connected to the circularly polarized antenna 4 (both of the timepiece movement and the communication module are not shown), inside a housing (not shown) made of a resin or the like. Further, the module 3 is formed, for example, to include a secondary battery 6 which stores electric power generated by the solar panel 5, a circuit board 7 on which there are mounted various electronic components such as a control circuit for performing time display using the clock hands 2 (see FIG. 2 with respect to the secondary battery and the circuit board), and the like, inside a housing (not shown) made of a resin or the like.

In the present embodiment, in an approximately central portion of the module 3, the hand spindle 31 is provided so as to protrude upward from the movement side.

The hand spindle 31 is a spindle in which a plurality of rotating shafts for the hour hand, the minute hand, the second hand, and the like are arranged so as to overlap on the same axis. The hand spindle 31 is inserted into a through-hole 51 of the solar panel 5 (described below) and the through-hole 11 of the dial plate 1. The individual rotating shafts are connected respectively to the clock hands 2 (such that the hour hand, the minute hand, and the second hand) corresponding to the rotating shafts.

When the hand spindle 31 rotates according to an operation of the movement, the various clock hands 2 which are fit on the individual rotating shafts of the hand spindle 31 individually rotate around the hand spindle 31 over the upper surface of the dial plate 1.

Also, in an end portion of the module 3 along the outer periphery of the module, the circularly polarized antenna 4 is arranged.

It is preferable that the circularly polarized antenna 4 is arranged such that the center of the circularly polarized antenna 4 is in an area range from 4 o'clock to 7 o'clock through 6 o'clock on the dial plate 1 as seen in a plan view.

The circularly polarized antenna 4 can receive GPS electric waves (that is, electric waves which are transmitted from GPS satellites and include time information and the like) which are microwaves which are circularly polarized waves. For example, a patch antenna can be preferably used.

GPS electric waves include data including time information according to high-accuracy atomic clocks mounted in the individual GPS satellites, appropriately accurate ephemerides (that is, trajectory information) of all satellites which are updated about every 6 days, and ephemerides of the satellites which are updated every 90 minutes. The individual GPS satellites transmit the above information to the earth by electric waves (microwaves) with a frequency of L1 (1575.42 MHz) or L2 (1227.60 MHz).

The timepiece 100 can receive a GPS electric wave from at least one of the plurality of GPS satellites by the circularly polarized antenna 4. And, The timepiece 100 can use the time information and the like included in the GPS electric wave to correct the internal time of the timepiece 100 to the exact time.

Also, GPS electric waves include trajectory information representing the positions of the individual GPS satellites on their trajectories as described above. Therefore, the timepiece 100 can also receive GPS electric waves transmitted respectively from the plurality of GPS satellites by the circularly polarized antenna 4, and use the time information, the trajectory information, and the like included in the GPS electric waves to perform positioning calculation.

As shown in FIG. 1, the circularly polarized antenna 4 of the present embodiment is formed in a rectangular shape as seen in a plan view. the circularly polarized antenna 4 includes a base 41 and a radiation electrode (radiation element) 42 disposed on the base 41. Also, the shape of the circularly polarized antenna 4 is not limited to the illustrated example.

The base 41 is made of a dielectric material such as ceramic.

The radiation electrode 42 consists of, for example, silver foil, a metal plate, a metal film, or the like with a predetermined thickness.

The size (the lengths of individual sides) of the radiation electrode 42 is optimized based on the frequency of electric waves which are received by the circularly polarized antenna 4, and the like. In the present embodiment, the size of the radiation electrode is adjusted such that the highest antenna characteristics are performed at the frequency band of the GPS electric waves.

Also, in the circularly polarized antenna 4, at a position having circular polarization characteristics, that is, at a position where impedance matching can be carried out, a power supply point 43 for supplying electric power to the radiation electrode 42 is provided.

Also, the method of supplying electric power to the radiation electrode 42 is not especially limited.

Also, at a position corresponding to the feeding point 43, a through-hole (not shown) may be formed in the thickness direction of the circularly polarized antenna 4. A power supply member (not shown) for supplying electric power to the radiation electrode 42 is inserted into the through-hole. The power supply member might be a power supply pin or a coaxial cable, for example.

The circularly polarized antenna 4 of the present embodiment is disposed in the module 3 while avoiding the hand spindle 31 (see FIG. 5). The position where the circularly polarized antenna 4 is provided is not limited to the illustrated example. And the direction in which the circularly polarized antenna 4 is arranged is not limited to the illustrated example.

In the circularly polarized antenna 4, a radiation pattern spreads from the peripheral portion (edge portion) of the radiation electrode 42.

In the present embodiment, the radiation electrode 42 is formed substantially in a square shape. The radiation pattern spreading from each side (peripheral portion) has a big influence on the antenna characteristics of the circularly polarized antenna 4 (the electric wave reception performance of the antenna).

Therefore, in order to improve the antenna characteristics of the circularly polarized antenna 4, it is important not to prevent spreading of the radiation pattern from the peripheral portion of the radiation electrode 42.

FIG. 2 is a schematic side view illustrating an internal configuration of the module 3.

As shown in FIG. 2, inside the module 3, the secondary battery 6 and the circuit board 7 described above are contained.

The secondary battery 6 is disposed below the circuit board 7. The secondary battery 6 is electrically connected to the circuit board 7.

The circuit board 7 electrically connects the secondary battery 6 and the solar panel 5. The circuit board 7 is electrically connected to the solar panel 5 disposed above the circuit board 7. Specifically, a positive electrode 71p on the circuit board 7 is electrically connected to the solar panel 5 (a solar cell 50a to be described below) through a connector (a connection member) 81p, and a negative electrode 71n is electrically connected to the solar panel 5 (a solar cell 50f to be described below) through a connector (a connection member) 81n.

FIG. 3 is a schematic block diagram illustrating a control configuration of the timepiece 100. FIG. 3 is for mainly explaining the power storing (charging) function of the timepiece 100.

As shown in FIG. 3, a central processing unit (CPU) 72 and a charging control circuit 73 are mounted on the circuit board 7. The central processing unit (CPU) 72 comprehensively controls individual units of the timepiece 100. The charging control circuit 73 controls an operation of charging the secondary battery 6 from the solar panel 5.

The CPU 72 is electrically connected to the charging control circuit 73 and controls an operation of the charging control circuit 73. Also, the CPU 72 is electrically connected to the communication module, the timepiece movement, and the like (not shown) connected to the circularly polarized antenna 4. The CPU 72 performs time correction based on time information and the like included in GPS electric waves.

The charging control circuit 73 is electrically connected to each of the solar panel 5 (a plurality of solar cells 50 to be described below) and the secondary battery 6, respectively. The charging control circuit 73 controls an operation of charging the secondary battery 6 from the solar panel 5, based on a control command from the CPU 72.

On a wiring route (in the present embodiment, on the positive electrode (71p) side) of the circuit board 7 between the solar panel 5 and the charging control circuit 73 (the secondary battery 6), an inductor 74 is electrically series-connected.

This inductor 74 is a choke coil for reducing influence (noise) of a current generated from the solar panel 5 on GPS electric wave reception of the circularly polarized antenna 4. In the present embodiment, the inductor 74 has an inductance value of about 1 mH. More specifically, the inductor 74 is a circuit element which increases impedance (electric resistance) with respect to electric waves with the predetermined frequency which are received by the circularly polarized antenna 4 while having low electric resistance (in the present embodiment, DC resistance) with respect to a generated current from the solar panel 5.

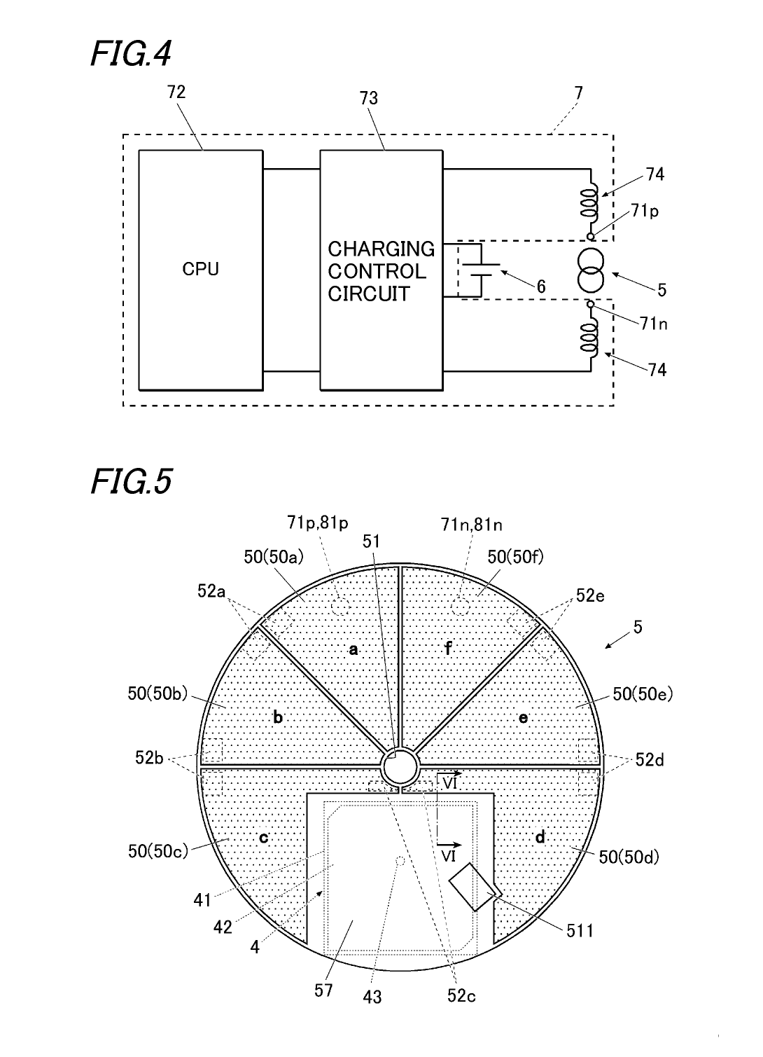

Also, the position where the inductor 74 is provided is not especially limited as long as it is on the wiring route between the solar panel 5 and the secondary battery 6. It is preferable that the position of the inductor 74 may be a position close to the solar panel 5. In order to suppress superposition of a high-frequency current on a circuit, it is more preferable that the position of the inductor 74 may be an intermediate position on a wiring route having a larger route length (conductor length). Therefore, the inductor 74 may be provided on a wiring route on the negative electrode (71n) side, not on the positive electrode (71p) side, and it is more preferable that two inductors 74 may be provided respectively on the positive electrode (71p) side and the negative electrode (71n) side as shown in FIG. 4.

As shown in FIG. 1, the solar panel 5 receives light and generates electric power. The electric power generated by the solar panel 5 is stored in the secondary battery 6.

The solar panel 5 of the present embodiment is disposed between the dial plate 1 and the module 3, and has an area corresponding to the area of the planar direction of the dial plate 1.

The dial plate 1 of the present embodiment is made of a material having optical transparency as described above. The area of the solar panel 5 corresponds to the area of the planar direction of the dial plate 1. Therefore, it is possible to maximally secure a light reception area of the solar panel 5.

Also, the shape and the like of the solar panel 5 are not especially limited. The solar panel 5 needs only to have an area substantially corresponding to the area of the planar direction of the dial plate 1 and substantially overlap the dial plate 1. The area and shape of the solar panel 5 may not coincide with the area and shape of the dial plate 1.

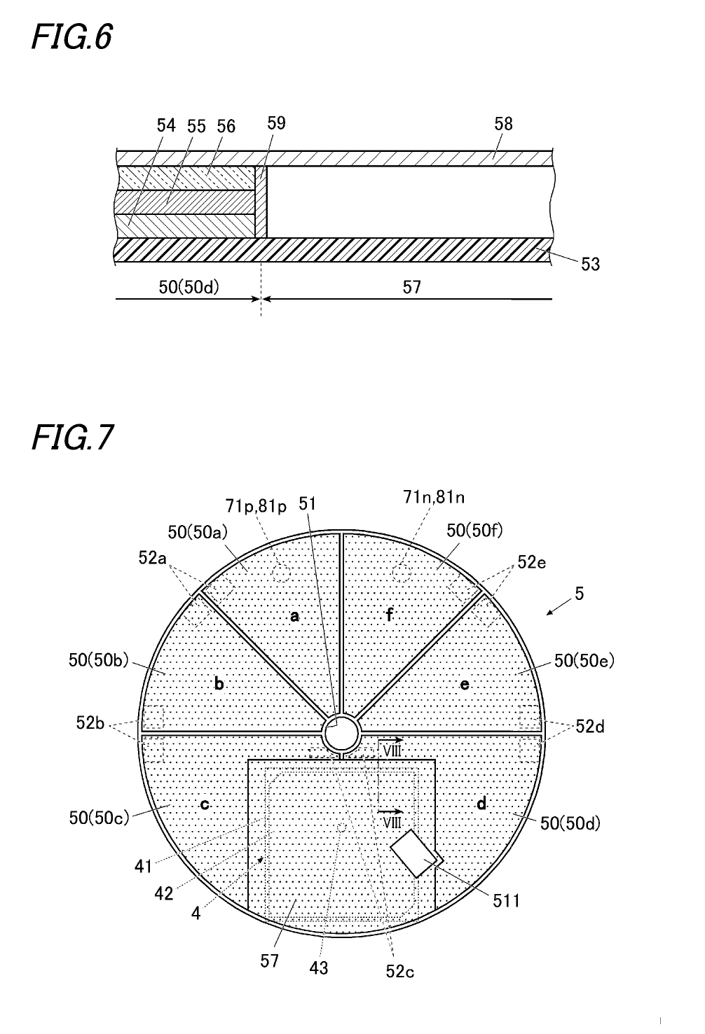

FIG. 5 is a plan view of the solar panel 5 according to the present embodiment, and FIG. 6 is a cross-sectional view of the solar panel 5 along a line VI-VI of FIG. 5.

As shown in FIGS. 1 and 5, in an approximately central portion of the solar panel 5, the through-hole 51 for inserting the hand spindle 31 is formed.

In the present embodiment, the solar panel 5 includes not only the plurality of solar cells 50 (in the present embodiment, six solar cells 50a to 50f) which is light receiving sections, but also a non-power generation section 57 disposed at a position corresponding to the radiation electrode 42 of the circularly polarized antenna 4.

Here, the position corresponding to the radiation electrode 42 is a position above the radiation electrode 42.

As described above, since the circularly polarized antenna 4 has the radiation pattern spreading from the peripheral portion of the radiation electrode 42, if the peripheral portion of the radiation electrode 42 is covered by a member inhibiting transmission of electric waves, the antenna characteristics (electric wave reception performance) deteriorates.

In order to prevent this, in the present embodiment, a portion of the solar panel 5 which is to be positioned above the radiation electrode 42 consists of the non-power generation section 57 which is made of only a non-conductive material, without containing conductive materials so as not to perform light reception and power generation.

Also, it is preferable that the size of the non-power generation section 57 may be slightly larger than the size of the radiation electrode 42. In the present embodiment, the non-power generation section 57 is formed such that each width of the non-power generation section 57 is larger than each width of the radiation electrode 42 by 2 mm approximately all over the circumference.

As shown in FIG. 6, the solar panel 5 has a structure in which metal electrodes 54, a semiconductor layer 55, and transparent electrodes 56 are sequentially stacked on a resin substrate 53 to constitute the individual solar cells 50. On the transparent electrodes 56, a protective layer (protective film) 58 is stacked. Also, an insulating layer 59 is disposed on the side surfaces of the laminate structures composed of the metal electrodes 54, the semiconductor layer 55, and the transparent electrodes 56 to constitute the individual solar cells 50.

The resin substrate 53 is a flexible film-like substrate. The material which forms the resin substrate 53 is not especially limited. The resin substrate 53 may be made of, for example, plastic.

The metal electrodes 54 are made of a material containing a metal material such as an aluminum conductor. Also, the material which forms the metal electrodes 54 is not limited thereto.

The semiconductor layer 55 is made of, for example, amorphous silicon (a-Si:H). As the semiconductor layer 55, for example, a p-n junction type semiconductor having a junction between a p-type semiconductor and an n-type semiconductor can be used.

The metal electrodes 54 and the semiconductor layer 55 are stacked on the resin substrate 53 by a method such as deposition. Also, the method of forming the metal electrodes 54 and the semiconductor layer 55 on the resin substrate 53 is not limited thereto.

Also, the transparent electrodes 56 are formed by crystallizing, for example, zinc oxide, indium oxide, or tin oxide on a substrate such as glass. Also, the material and formation method of the transparent electrodes 56 are not limited thereto.

Also, the non-power generation section 57 of the solar panel 5 is formed by removing the metal electrodes 54, the semiconductor layer 55, and the transparent electrodes 56 which are portions to be positioned above the radiation electrode 42.

The method of removing the metal electrodes 54, the semiconductor layer 55, and the transparent electrodes 56 is not especially limited. For example, laser processing can be used. Also, instead of removing the metal electrodes 54, the semiconductor layer 55, and the transparent electrodes 56 stacked, the metal electrodes 54, the semiconductor layer 55, and the transparent electrodes 56 may be stacked while avoiding the portion where the non-power generation section 57 will be provided (that is, the portion to be positioned above the radiation electrode 42).

In the present embodiment, the six solar cells 50a to 50f are formed so as to have approximately equal areas as shown in FIGS. 1 and 5 such that the output currents of the individual solar cells become substantially equal.

The solar cells 50a to 50f are connected in series, and functions as one solar panel.

Specifically, the solar cell 50a is electrically connected to the neighboring solar cell 50b at a connection portion 52a, and the solar cell 50b is electrically connected to the neighboring solar cell 50c at a connection portion 52b. In the same way, the solar cells 50c to 50e are electrically connected to the neighboring solar cells 50d to 50f at connection portions 52c to 52e.

Also, the solar cell 50a is electrically connected to the positive electrode 71p on the circuit board 7, through the connector 81p. The solar cell 50f is electrically connected to the negative electrode 71n on the circuit board 7, through the connector 81n (see FIG. 2).

As a result, the six solar cells 50a to 50f are electrically connected to the circuit board 7 in a state where they are connected in series.

Also, the connection positions where the solar panel 5 and the circuit board 7 are electrically connected, that is, the positions of the two electrodes 71p and 71n of the circuit board 7 or the two connectors 81p and 81n are not especially limited as long as the six solar cells 50a to 50f are connected in series while being electrically connected to the circuit board 7, and may be, for example, on the solar cell 50c and the solar cell 50d.

It is preferable that the connection positions may be positions apart from the circularly polarized antenna 4 like in the present embodiment. Specifically, in a case of defining a boundary line as a line passing through the center of the solar panel 5 while being perpendicular to a line connecting the center of the circularly polarized antenna 4 and the center of the solar panel 5, it is preferable that, as seen in a plan view of the solar panel, the connection positions may be provided in the opposite area (the upper half area of FIG. 5) to an area (the lower half area of FIG. 5) where the circularly polarized antenna 4 is provided across the boundary line, in the solar panel 5. In a case where the circularly polarized antenna 4 is positioned as described above such that the center is in the area range from 4 o'clock to 7 o'clock through 6 o'clock on the dial plate 1 as seen in a plan view, it is more preferable that the corresponding connection positions may be in an area range from 8 o'clock to 12 o'clock through 2 o'clock on the dial plate 1 (see FIG. 1). Also, the circularly polarized antenna 4 is positioned while avoiding the center of the solar panel 5 in this case.

Like this, since the connection positions of the solar panel 5 and the circuit board 7 are spaced apart from the circularly polarized antenna 4, conductive materials (such as the two electrodes 71p and 71n or the two connectors 81p and 81n) which are provided at the connection positions are disposed at positions apart from the circularly polarized antenna 4. Therefore, the impedance of the solar panel 5 around the position above the circularly polarized antenna 4 becomes higher than the impedance of the solar panel 5 in the vicinities of the connection positions apart from the circularly polarized antenna 4. It is possible to reduce a bad influence (electromagnetic shield effect) of the conductive materials of the solar panel 5 (such as the metal electrodes 54, the semiconductor layer 55, and the transparent electrodes 56 of the solar cells 50) on GPS electric wave reception of the circularly polarized antenna 4.

Also, in the present embodiment, a date wheel (not shown) is disposed in the module 3, and a date display window 12 for displaying date is formed in the dial plate 1.

Further, in the solar panel 5, at a position corresponding to the date display window 12 of the dial plate 1, a date display opening 511 is formed.

In the present embodiment, the date display opening 511 is formed in the non-power generation section 57 which is a part of the solar panel 5 and does not perform light reception and power generation.

Therefore, it is possible to provide the date display opening 511 while suppressing influence on the power generation amount of the solar panel 5, and rarely reducing the total area of the plurality of solar cells 50.

Next, the action of the timepiece 100 according to the present embodiment will be described.

In the timepiece 100 of the present embodiment, if light passing through the dial plate 1 from the viewable side enters the solar panel 5 having the solar cells 50a to 50f, the light enters the semiconductor layer 55 through the transparent electrodes 56. If the light enters the semiconductor layer 55, electrons and holes are generated around the junction between the p-type semiconductor and the n-type semiconductor. The generated electrons and holes move toward the n-type semiconductor and the p-type semiconductor, respectively, whereby an electromotive force (photoelectromotive force) is generated. As a result, current flows in circuits connected to the transparent electrodes 56 and the metal electrodes 54. Electric power generated in this way by the solar panel 5 is stored in the secondary battery 6 through the circuit board 7.

In this case, the inductor 74 provided on the wiring route on the circuit board 7 from the solar panel 5 to the secondary battery 6 has electric resistance of almost 0Ω to the generated current (DC current) from the solar panel 5, and thus does not block the generated current. As a result, electric power generated by the solar panel 5 is appropriately stored in the secondary battery 6.

Also, in the timepiece 100, GPS electric waves passing through the dial plate 1 enter the circularly polarized antenna 4. Then, the CPU 72 on the circuit board 7 corrects the internal time of the timepiece 100 to the exact time, based on time information and the like included in the GPS electric waves received by the circularly polarized antenna 4.

In this case, due to the inductor 74 provided on the wiring route on the circuit board 7 from the solar panel 5 to the secondary battery 6, the impedance of a charging circuit connecting the solar panel 5 and the secondary battery 6 at the frequency of the GPS electric waves becomes extremely high.

Specifically, the impedance Z of the circuit is ideally expressed by Z=2πfL. Here, f is the frequency of a signal, and L is the inductance value of the circuit. Since the frequency of the GPS electric waves is about 1.5 GHz as described above, and the inductance value of the inductor 74 is about 1 mH as described above, from the above expression, the impedance Z of the corresponding charging circuit at the frequency of the GPS electric waves becomes about 10 kΩ.

Like this, since the impedance of the charging circuit at the frequency of the GPS electric waves increases, at the corresponding frequency, a current rarely flows in the charging circuit. Therefore, at the frequency of the GPS electric waves, since it is possible to make the electrical connection state of the solar panel 5 and the circuit board 7 an open state, it is possible to reduce a bad influence (electromagnetic shield effect) of the conductive materials of the solar panel 5 (such as the metal electrodes 54, the semiconductor layer 55, and the transparent electrodes 56 of the solar cells 50) on GPS electric wave reception of the circularly polarized antenna 4.

Also, in this case, since the peripheral portion of the radiation electrode 42 of the circularly polarized antenna 4 is covered by the conductive materials (such as the metal electrodes 54, the semiconductor layer 55, and the transparent electrodes 56 of the solar cells 50), spreading of the radiation pattern is not inhibited, and the circularly polarized antenna 4 can appropriately receive GPS electric waves.

As described above, according to the present embodiment, on the wiring route provided on the circuit board 7 so as to electrically connect the solar panel 5 and the secondary battery 6, the inductor 74 is provided so as to have low DC resistance to a generated current from the solar panel 5 while increasing impedance to electric waves which are received by the circularly polarized antenna 4.

Therefore, it is possible to increase the impedance of the charging circuit at the frequency of GPS electric waves, without blocking a generated current from the solar panel 5 to the secondary battery 6, thereby reducing a bad influence of the conductive materials of the solar panel 5 on GPS electric wave reception of the circularly polarized antenna 4. Therefore, even in a case where the solar panel 5 is disposed above the circularly polarized antenna 4, it is possible to appropriately perform GPS electric wave reception of the circularly polarized antenna 4 and charging of the secondary battery 6, by simply providing only inductor 74 on the wiring route connecting the solar panel 5 and the secondary battery 6.

Also, if two inductors 74 are provided on two wiring routes on the positive electrode (71p) side and negative electrode (71n) side of the circuit board 7, respectively, it is possible to further reduce a bad influence of the conductive materials of the solar panel 5 on GPS electric wave reception of the circularly polarized antenna 4.

Also, according to the present embodiment, the connection positions where the solar panel 5 and the circuit board 7 are electrically connected are positions apart from the circularly polarized antenna 4. That is, in a case of defining a boundary line as a line passing through the center of the solar panel 5 while being perpendicular to a line connecting the center of the circularly polarized antenna 4 and the center of the solar panel 5, as seen in a plan view, the connection positions are provided in the opposite area of the corresponding boundary line to the area where the circularly polarized antenna 4 is provided, in the solar panel 5.

Therefore, the conductive materials (such as the two electrodes 71p and 71n or the two connectors 81p and 81n) which are provided at the connection positions are disposed at positions apart from the circularly polarized antenna 4, and the impedance of the solar panel 5 around the position above the circularly polarized antenna 4 becomes higher than the impedance of the solar panel 5 in the vicinities of the connection positions apart from the circularly polarized antenna 4. Therefore, it is possible to further reduce a bad influence of the conductive materials of the solar panel 5 on GPS electric wave reception of the circularly polarized antenna 4.

Also, according to the present embodiment, the circularly polarized antenna 4 is disposed below the solar panel 5, and the solar panel 5 has the non-power generation section 57 made of a non-conductive material at the position corresponding to the radiation electrode 42 of the circularly polarized antenna 4.

Therefore, the peripheral portion of the radiation electrode 42 is not covered by a conductive material. Therefore, it is possible to suppress deterioration of the antenna characteristics of the circularly polarized antenna 4, and appropriately receive GPS electric waves.

Also, it goes not without saying that embodiments to which the present invention can be applied are not limited to the above described embodiment, and various modifications can be made without departing from the scope of the present invention.

For example, in the above described embodiment, as a circuit element for increasing impedance to electric waves with the predetermined frequency which are received by the circularly polarized antenna 4, the inductor 74 which is a choke coil having an inductance value of about 1 mH is provided. However, the circuit element is not limited thereto, and may be a choke coil having any other inductance value, or may be any other EMC countermeasure component such as a filter.

Also, in the above described embodiment, the non-power generation section 57 which is provided at the position of the solar panel 5 corresponding to the radiation electrode 42 consists of the non-conductive material remaining by removing the conductive materials (the metal electrodes 54 and the transparent electrodes 56) and the like. However, instead of providing this non-power generation section 57, an opening (a portion where the resin substrate 53 and the protective layer 58 do not exist) is formed at the position corresponding to the radiation electrode 42.

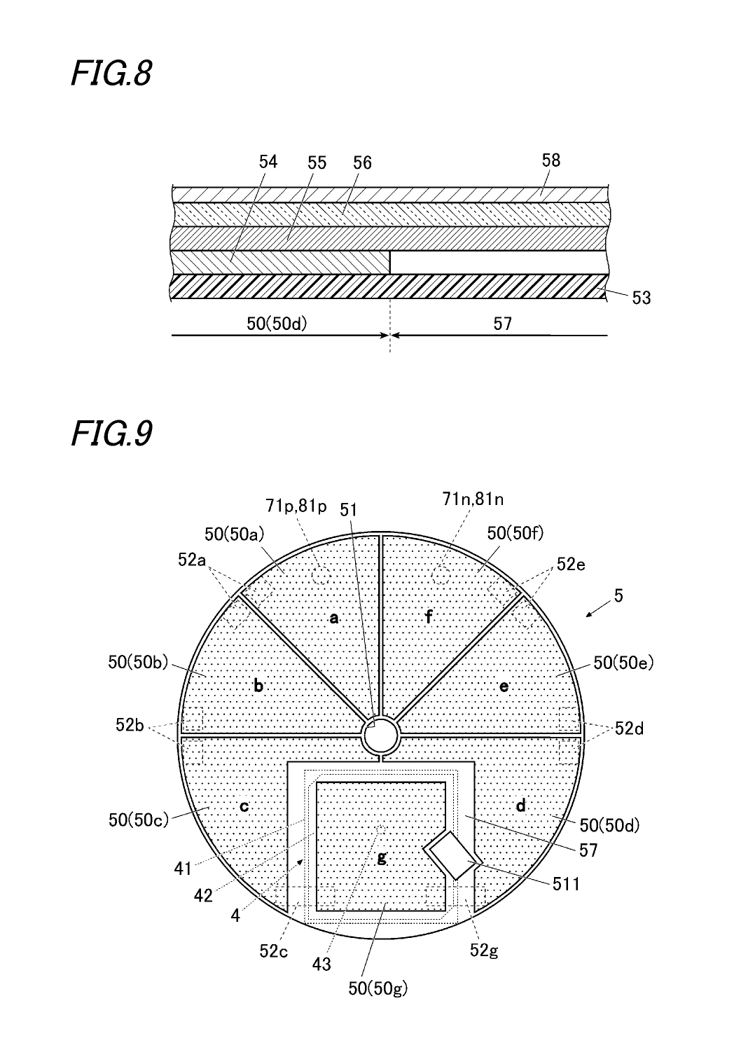

Also, the non-power generation section 57 of the solar panel 5 may be formed by removing only the metal electrodes 54 as shown in FIGS. 7 and 8.

Here, FIG. 7 is a plan view illustrating a modification of the solar panel 5, and FIG. 8 is a cross-sectional view along a line VIII-VIII of FIG. 7.

As shown in FIGS. 7 and 8, the non-power generation section 57 may be provided by removing only the metal electrodes 54, such that it has the semiconductor layer 55 and the transparent electrodes 56 like the solar cells 50. Although the transparent electrodes 56 is configured by a conductive material, since the electrical conductivity of the transparent electrodes 56 is lower than the metal electrodes 54 which is configured by an aluminum conductor or the like, a bad influence on the antenna characteristics of the circularly polarized antenna 4 is relatively small.

Also, since the non-power generation section 57 has the transparent electrodes 56 and the semiconductor layer 55 positioned on the front side, like the solar cells 50, when the timepiece 100 is viewed from the dial plate (1) side, the solar cells 50 and the non-power generation section 57 look the same.

Therefore, if the non-power generation section 57 is configured by removing only the metal electrodes 54, it is possible to suppress deterioration of the antenna characteristics of the circularly polarized antenna 4 while improving designability.

Also, the non-power generation section 57 of the solar panel 5 may be provided at a position corresponding to the peripheral portion of the radiation electrode 42 as shown in FIG. 9.

Here, FIG. 9 is a plan view illustrating another modification of the solar panel 5.

As shown in FIG. 9, the non-power generation section 57 may be provided in an annular shape only at a position corresponding to the peripheral portion of the radiation electrode 42 of the circularly polarized antenna 4, not over the entire radiation electrode 42. As described above, in order to keep good antenna characteristics of the circularly polarized antenna 4, it is important not to prevent spreading of the radiation pattern from the peripheral portion of the radiation electrode 42. For this reason, if the non-power generation section 57 is provided only at a position corresponding to the peripheral portion of the radiation electrode 42, that is, a position above the corresponding peripheral portion, it is possible to sufficiently expect an effect to suppress deterioration of the antenna characteristics of the circularly polarized antenna 4. In this case, the non-power generation section 57 may be formed by removing only the metal electrodes 54 like in the above described modification.

Also, in this case, if an addition solar cell 50 (a solar cell 50g) is provided on the inner side from the non-power generation section 57 (an area surrounded by the non-power generation section 57), it is possible to secure a wider light receiving section of the solar panel 5, thereby improving power generation capacity. Also, in this case, it goes without saying that the added solar cell 50g is electrically connected in series to the other solar cells 50a to 50f (for example, by connection portions 52c and 52g in FIG. 9) and is formed so as to have an area substantially equal to those of the other solar cells 50a to 50f.

Therefore, if the non-power generation section 57 is provided at a position corresponding to the peripheral portion of the radiation electrode 42, it is possible to suppress deterioration of the antenna characteristics of the circularly polarized antenna 4 while improving the power generation capacity of the solar panel 5.

Also, the division method of the solar panel (such as the number of partitions and the shape of each divided solar cell) is not limited to that exemplified in the above described embodiment.

Also, in the above described embodiment, a case of providing one circularly polarized antenna 4 has been exemplified. However, the number of circularly polarized antennae 4 to be provided in the timepiece is not limited thereto.

Also, the antenna according to the present invention is not limited to a circularly polarized antenna for receiving GPS electric waves, and needs only to be an antenna able to receive electric waves with a predetermined frequency, such as an antenna corresponding to Bluetooth (a registered trademark) or any other high-frequency wireless communication.

Also, in the above described embodiment, a case where the timepiece which is the electronic device is the analog type timepiece 100 which rotates the clock hands 2 on the dial plate 1, thereby displaying time and the like has been exemplified. However, the timepiece is not limited to the analog type timepiece.

The timepiece may be, for example, a digital type timepiece having a dial plate (such as a liquid crystal display unit) for displaying various information such as time and calendar information by characters and the like. Also, a dial plate having both of an analog type display unit and a digital type display unit may be included in the electronic device.

Also, in the above described embodiment, a case where the electronic device according to the present invention is a timepiece (electronic timepiece) has been exemplified. However, the corresponding electronic device is not limited thereto.

The electronic device according to the present invention needs only to perform photovoltaic power generation by a solar panel, store the generated electric power in a secondary battery, and receive electric waves with a predetermined frequency by an antenna disposed near the solar panel, and may be, for example, a biological information display such as a pedometer, a heart rate meter, or a pulsimeter, or a display for displaying various information such as movement distance and movement pace information, altitude information, and air pressure information.

Though several embodiments of the present invention have been described above, the scope of the present invention is not limited to the above embodiments, and includes the scope of inventions, which is described in the scope of claims, and the scope equivalent thereof.

What is claimed is:

1. An electronic device comprising:
a solar panel that receives light to generate electric power;
a secondary battery that stores electric power generated by the solar panel;
an antenna that is disposed near the solar panel and that receives electric waves with a predetermined frequency; and
a circuit board that electrically connects the solar panel and the secondary battery,
wherein, on a wiring route which is formed on the circuit board so as to electrically connect the solar panel and the secondary battery, at least one circuit element is provided so as to have high electric resistance with respect to electric waves which are received by the antenna while having low electric resistance with respect to a generated current from the solar panel.

2. The electronic device according to claim 1, wherein:
the circuit board includes a positive electrode and a negative electrode to which the solar panel is electrically connected respectively, and
circuit elements are provided on a wiring route of a positive electrode side and on a wiring route of a negative electrode side, respectively.

3. The electronic device according to claim 1, wherein:
the solar panel and the circuit board are electrically connected at connection positions,
a boundary line passes through a center of the solar panel and is perpendicular to a line connecting a center of the antenna and the center of the solar panel, and
the connection positions are provided in an opposite area to an area where the antenna is provided across the boundary line, in a plan view of the solar panel.

4. The electronic device according to claim 2, wherein:
the solar panel and the circuit board are electrically connected at connection positions,
a boundary line passes through a center of the solar panel and is perpendicular to a line connecting a center of the antenna and the center of the solar panel, and
the connection positions are provided in an opposite area to an area where the antenna is provided across the boundary line, in a plan view of the solar panel.

5. The electronic device according to claim 1, wherein:
the electronic device is an electronic timepiece for displaying time.

6. The electronic device according to claim 2, wherein:
the electronic device is an electronic timepiece for displaying time.

7. The electronic device according to claim 3, wherein:
the electronic device is an electronic timepiece for displaying time.

8. The electronic device according to claim 4, wherein:
the electronic device is an electronic timepiece for displaying time.
